(19) United States
(12) Patent Application Publication
(10) Pub. No.: US 2007/0016536 A1
(43) Pub. Date: Jan. 18, 2007

(54) Aggregate Product Pricing Management in an E-Commerce Application

(75) Inventors: Lev Mirlas, Thornhill, Ontario (CA); Michael C. Rabbior, Richmond Hill, Ontario (CA)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/160,866

(22) Filed: Jul. 13, 2005

(51) Int. Cl. G06F 17/00

(52) U.S. Cl. 705/400

(57) ABSTRACT

The present invention addresses deficiencies of the art in respect to aggregate product management. By pricing aggregate products in an e-commerce application. Aggregated product pricing management can include approximating a requested configuration for an aggregate product with a pre-defined configuration for the aggregate product and modifying a base price for the pre-defined configuration to account for determined additions, removals and replacements of components in the pre-defined configuration specified by the requested configuration. Furthermore, the invention can include approximating the requested configuration and modifying the base price for different contracts specifying different prices for components and pre-defined configurations and selecting a lowest resulting modified base price among resulting modified based prices produced by the modifying for each of the different contracts.

The present invention relates to the field of e-commerce systems and more particularly to the defining and pricing of aggregated products in an e-commerce application.

### DESCRIPTION OF THE RELATED ART

E-commerce systems have evolved to provide virtual storefronts whose operational capabilities far exceed those of the traditional, brick and mortar store. Whereas in the brick and mortar store, each of the sales, marketing, order fulfillment, inventory, and customer service functions remain the separate responsibilities of corresponding business roles, in a well-defined e-commerce system, each of the sales, marketing, order fulfillment, inventory and customer service can be integrated in a single computing system in a highly automated fashion. Consequently, a more optimal business operation can result in which data flows between different functional subsystems seamlessly to facilitate the daily conduct of business managed by the e-commerce system.

In the prototypical e-commerce system, an on-line catalog of available goods and/or services for sale can be established along with associated pricing. Customers can be provided with a store front user interface through which customers can browse the on-line catalog. When a customer desires to purchase a product or service, the customer can so indicate causing the addition of the selected product or service to an on-line shopping cart, though it is also known to bypass the shopping cart model in favor of direct purchase model.

The sales catalog allows the customers to browse for products. Conventionally known as a navigational catalog, it is a hierarchical map of categories having as an example, products, SKUs and kits. Notably, a store can have multiple sales catalogs and each can be organized for display to the customers, usually for merchandising purposes. Additionally, the sales catalog can have products assigned to multiple categories and a category can have more than one parent to form a map rather than a tree.

E-commerce systems often manage the sale of products and services which are nothing more than an aggregation of other products and services also sold individually through the e-commerce system. Often referred to as a dynamic kit (as opposed to static kits), an aggregation can be pre-configured under one sale price, or the price of the aggregation can be computed dynamically based upon the constituent components. Often, aggregate products are priced at a level equivalent to the sum total of the individual prices for the components in the aggregation. Other times, aggregate products are priced at a level below the sum total of the individual prices for the components in the aggregation.

Regardless, the manner in which these aggregate products are priced can have a significant impact on whether or not the aggregation will be successfully sold. Pricing can be of paramount importance where competitive products offered in the market space have little differentiation from one another aside from price as in the case of the computing marketplace. Accordingly, a greater flexibility in the programmatic pricing of aggregate products in an e-commerce application can provide an advantage in the marketplace.

### BRIEF SUMMARY OF THE INVENTION

Embodiments of the present invention address deficiencies of the art in respect to aggregate product management and provide a novel and non-obvious method, system and computer program product for pricing aggregate products in an e-commerce application. In an embodiment of the invention, a method for aggregated product pricing management can include approximating a requested configuration for an aggregate product with a pre-defined configuration for the aggregate product and modifying a base price for the pre-defined configuration to account for determined additions, removals and replacements of components in the pre-defined configuration specified by the requested configuration. The method further can include approximating the requested configuration and modifying the base price for different contracts specifying different prices for components and pre-defined configurations and selecting a lowest resulting modified base price among resulting modified based prices produced by the modifying for each of the different contracts.

In another embodiment of the invention, a data processing system for aggregated product pricing management can include an e-commerce application including each of ordering, pricing and configuration logic. The system further can include a catalog of pre-defined configurations for an aggregate product coupled to the e-commerce application. Finally, the system can include aggregate product management logic enabled to approximate a requested configuration for an aggregate product with a pre-defined configuration for the aggregate product defined in the catalog, and to modify a base price for the pre-defined configuration to account for determined additions, removals and replacements of components in the pre-defined configuration specified by the requested configuration. Optionally, the logic can be enabled to repeatedly approximate the requested configuration and modify the base price utilizing different pricing information specified by different contracts in order to select a lowest resulting price produced according to the set of contracts.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for aggregate product management; and,

FIG. 2 is a flow chart illustrating a process for aggregate product management for use in the system of FIG. 1.

### DETAILED DESCRIPTION OF THE INVENTION

Embodiments of the present invention provide a method, system and computer program product for aggregate product management in an e-commerce system. In accordance with an embodiment of the present invention, a price can be requested for an aggregate product. An aggregate product can include products having multiple components such as personal computers, for example. The configuration for the requested aggregate product can be compared to one or more pre-determined configurations for similar aggregate products to determine whether the requested product configuration has already been priced.

If the requested product configuration has not already been priced in a similar, pre-determined configuration, the requested configuration for the aggregate product can be priced based upon the sum of the pricing for its constituent components. Otherwise, the price for the pre-determined configuration can be modified to account for replacement components, added components and removed components. Finally, the pricing process can be repeated for multiple, different pricing contracts. Subsequently, the lowest resulting price among the different pricing contracts can be selected for use.

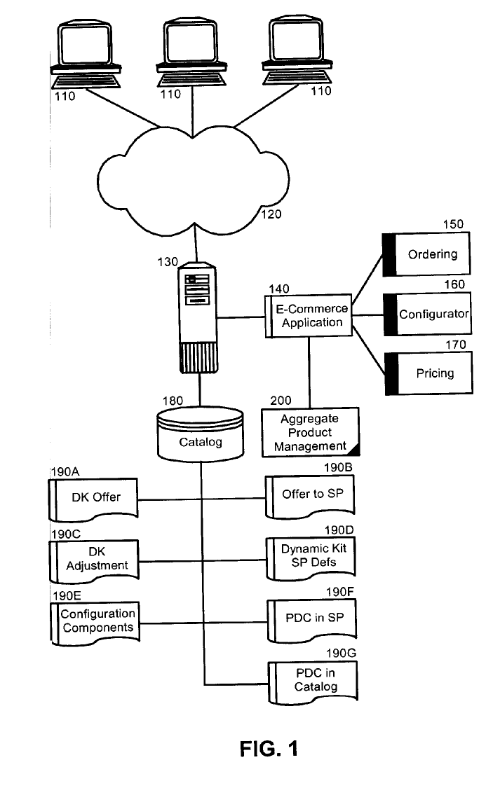

In more particular illustration, FIG. 1 is a schematic illustration of a data processing system configured for aggregate product management. As shown in FIG. 1, the data processing system can include a host computing platform 130 configured to host an e-commerce application 140 which can be accessed by one or more client computing devices 110 over a computer communications network 120. The host computing platform 130 further can be coupled to a catalog 180 from which aggregate products can be ordered by shoppers through the client computing devices 110.

The e-commerce application 140 can include an ordering component 150, a pricing component 170 and also a configurator 160 for configuring an aggregate product by adding, removing or replacing components in a predefined product configuration. The e-commerce application 140 further can include aggregate product management logic 200. The aggregate product management logic 200 can be enabled to determine pricing for a requested aggregate product across multiple pricing contracts for different customers or classes of customers. The aggregate product management logic 200 further can be enabled to select a lowest determined price among the contracts for presentation to shoppers requesting a price quotation for a designated aggregate product.

To facilitate the pricing of a requested aggregate product, the catalog 180 can include several tables 190A-190G. For instance, the catalog 180 can include a dynamic kit offer table 190A which can store the component prices for included components in a specified aggregate product. The catalog 180 also can include an offer to starting point table 190B which can associate a requested aggregate product with a closest matching pre-defined configuration for an aggregate product. The catalog 180 yet further can include a dynamic kit adjustment table 190C which can store additions to, replacements of, and subtractions of components in a pre-defined configuration for an aggregate product.

The catalog 180 also can include a dynamic kit starting point definitions table 190D which can store starting point definitions for pre-defined configurations for respective aggregate products. The catalog 180 also can include a configuration components table 190E which can include listings of components in each pre-defined configuration of an aggregate product. The catalog 180 also can include a pre-defined configuration in a starting point table 190F which can store the name and description of each pre-defined configuration of an aggregate product in a starting point. Finally, the catalog 180 can include a pre-defined configuration in a catalog table 190G which can indicate an ordering of each pre-defined configuration in the catalog 180.

In operation, utilizing the tables 190A-190G, the aggregate product management logic 200 can approximate a requested configuration for an aggregate product with a pre-defined configuration for the aggregate product. A base price for the pre-defined configuration thus can be established as a starting point for the pricing of the requested configuration. Subsequently, requested additions of components to the pre-defined configuration can be determined based upon the requested configuration so as to compute an adjusted price. As well, requested removals of components from the pre-defined configuration can be determined based upon the requested configuration to compute an adjusted price. Finally, replacements of components in the pre-defined configuration can be determined based upon the requested configuration to determine the new price for the requested configuration.

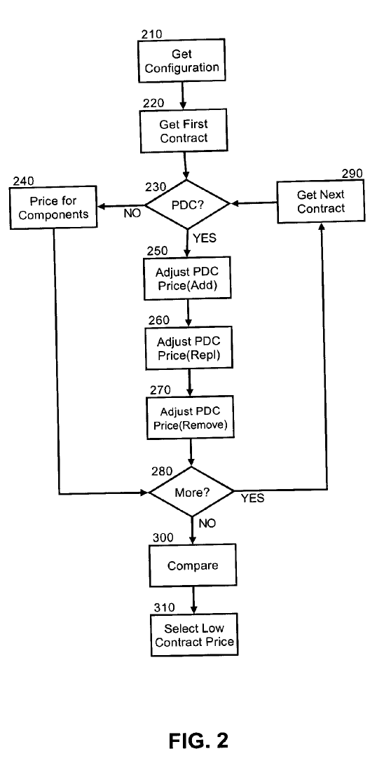

Notably, pricing can be computed for a requested configuration across multiple different contract pricing schemes for different customer types or customers. Consequently, the lowest computed price among all of the contracts can be selected for the requested configuration. In more particular illustration, FIG. 2 is a flow chart illustrating a multi-contract process for aggregate product management for use in the system of FIG. 1.

Beginning in block 210, a requested configuration for an aggregate product can be received for processing. In block 220, a first contract can be retrieved for consideration. Subsequently, in decision block 230 it can be determined whether the requested configuration can be approximated to a pre-defined configuration. For example, it can be determined whether one or more pre-defined configurations include at least a majority of the components specified in the requested configuration. If not, in block 240, the price for the requested configuration can be computed as the sum of the pricing for the individual components in the aggregation. Otherwise, the process can continue in block 250.

In block 250, the components of the requested configuration can be compared to the components of the pre-determined configuration to identify component additions. For each identified addition, the contract price of the addition can be added to the contract price for the pre-defined configuration. Likewise, in block 260, replacement components for components in the pre-defined configuration can be identified and the contract price of the replacement component can be added to the contract base price while the contract price for the replaced component can be subtracted from the contract base price of the pre-defined configuration. Finally, in block 270, removed components from the pre-defined configuration can be identified and the contract price of the removed components can be subtracted from the contract base price of the pre-defined configuration. An ultimate contract price for the requested configuration can result.

In decision block 280, it can be determined whether additional contracts are available for processing. If so, a next pricing contract can be retrieved in block 290 and the process of blocks 230 through 280 can repeat until no further pricing contracts are available for processing. When no further pricing contracts are available, in block 300 all of the computed prices of the different contracts can be compared. Subsequently, in block 310, the lowest computed price can be selected for presentation to a shopping customer. As such, more control and finer tuning of how aggregate products are priced can be provided—a powerful advantage over those competitors that do not possess the same capability.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A method for aggregated product pricing management comprising:
approximating a requested configuration for an aggregate product with a pre-defined configuration for the aggregate product; and,
modifying a base price for said pre-defined configuration to account for determined additions, removals and replacements of components in said pre-defined configuration specified by said requested configuration.

2. The method of claim 1, wherein said approximating a requested configuration for an aggregate product with a pre-defined configuration for the aggregate product comprises selecting a pre-defined configuration having at least a majority of components in said requested configuration.

3. The method of claim 1, wherein said approximating a requested configuration for an aggregate product with a pre-defined configuration for the aggregate product comprises:
determining whether a pre-defined configuration can be selected to approximate said requested configuration;
computing a base price comprising a sum of prices for components in said requested configuration if a pre-defined configuration cannot be determined to approximate said requested configuration; and,
approximating said requested configuration for said aggregate product with a pre-defined configuration for the aggregate product if a pre-defined configuration can be determined to approximate said requested configuration.

4. The method of claim 1, wherein said modifying a base price for said pre-defined configuration to account for determined additions, removals and replacements of components in said pre-defined configuration specified by said requested configuration comprises:
identifying additional components in said requested configuration which are not present in said pre-defined configuration;
determining a price for each of said identified additional components; and,
adding each said determined price to said base price.

5. The method of claim 1, wherein said modifying a base price for said pre-defined configuration to account for determined additions, removals and replacements of components in said pre-defined configuration specified by said requested configuration comprises:
identifying replacement components in said requested configuration which replace existing components in said pre-defined configuration;
determining a price for each of said identified replacement components;
further determining a price for each of said existing components; and,
adding each said determined price to said base price and subtracting each said further determined price from said base price.

6. The method of claim 1, wherein said modifying a base price for said pre-defined configuration to account for determined additions, removals and replacements of components in said pre-defined configuration specified by said requested configuration comprises:
identifying missing components in said requested configuration which are present in said pre-defined configuration;
determining a price for each of said missing components; and,
subtracting each said determined price from said base price.

7. The method of claim 1, further comprising:
approximating said requested configuration and modifying said base price for different contracts specifying different prices for components and pre-defined configurations; and,
selecting a lowest resulting modified base price among resulting modified based prices produced by said modifying for each of said different contracts.

8. A data processing system for aggregated product pricing management comprising:
an e-commerce application comprising each of ordering, pricing and configuration logic;
a catalog of pre-defined configurations for an aggregate product coupled to said e-commerce application; and,
aggregate product management logic enabled to approximate a requested configuration for an aggregate product with a pre-defined configuration for the aggregate product defined in said catalog, and to modify a base price for said pre-defined configuration to account for determined additions, removals and replacements of components in said pre-defined configuration specified by said requested configuration.

9. The data processing system of claim 8, further comprising a set of contracts, each of said contracts specifying pricing for one of a customer or customer class for different components in said catalog and for different pre-defined configurations in said catalog.

10. The data processing system of claim 9, wherein said aggregate product management logic is further enabled to repeatedly approximate said requested configuration and modify said base price utilizing different pricing information specified by different ones of said contracts in order to select a lowest resulting price produced according said set of contracts.

11. A computer program product comprising a computer usable medium having computer usable program code for aggregated product pricing management, said computer program product including:
computer usable program code for approximating a requested configuration for an aggregate product with a pre-defined configuration for the aggregate product; and,
computer usable program code for modifying a base price for said pre-defined configuration to account for determined additions, removals and replacements of components in said pre-defined configuration specified by said requested configuration.

12. The computer program product of claim 11, wherein said computer usable program code for approximating a requested configuration for an aggregate product with a pre-defined configuration for the aggregate product comprises computer usable program code for selecting a pre-defined configuration having at least a majority of components in said requested configuration.

13. The computer program product of claim 11, wherein said computer usable program code for approximating a requested configuration for an aggregate product with a pre-defined configuration for the aggregate product comprises:
computer usable program code for determining whether a pre-defined configuration can be selected to approximate said requested configuration;
computer usable program code for computing a base price comprising a sum of prices for components in said requested configuration if a pre-defined configuration cannot be determined to approximate said requested configuration; and,
computer usable program code for approximating said requested configuration for said aggregate product with a pre-defined configuration for the aggregate product if a pre-defined configuration can be determined to approximate said requested configuration.

14. The computer program product of claim 11, wherein said computer usable program code for modifying a base price for said pre-defined configuration to account for determined additions, removals and replacements of components in said pre-defined configuration specified by said requested configuration comprises:
computer usable program code for identifying additional components in said requested configuration which are not present in said pre-defined configuration;
computer usable program code for determining a price for each of said identified additional components; and,
computer usable program code for adding each said determined price to said base price.

15. The computer program product of claim 11, wherein said computer usable program code for modifying a base price for said pre-defined configuration to account for determined additions, removals and replacements of components in said pre-defined configuration specified by said requested configuration comprises:
computer usable program code for identifying replacement components in said requested configuration which replace existing components in said pre-defined configuration;
computer usable program code for determining a price for each of said identified replacement components;
computer usable program code for further determining a price for each of said existing components; and,
computer usable program code for adding each said determined price to said base price and subtracting each said further determined price from said base price.

16. The computer program product of claim 11, wherein said computer usable program code for modifying a base price for said pre-defined configuration to account for determined additions, removals and replacements of components in said pre-defined configuration specified by said requested configuration comprises:
computer usable program code for identifying missing components in said requested configuration which are present in said pre-defined configuration;
computer usable program code for determining a price for each of said missing components; and,
computer usable program code for subtracting each said determined price from said base price.

17. The computer program product of claim 11, further comprising:
computer usable program code for approximating said requested configuration and modifying said base price for different contracts specifying different prices for components and pre-defined configurations; and,
computer usable program code for selecting a lowest resulting modified base price among resulting modified based prices produced by said modifying for each of said different contracts.
